(19) United States
(12) Patent Application Publication
(10) Pub. No.: US 2011/0216567 A1
(43) Pub. Date: Sep. 8, 2011

(54) Single switch inverter

(75) Inventor: Jianping Fan, Orange, CA (US)

(73) Assignee: SUNTEC ENTERPRISES

(21) Appl. No.: 12/660,585

(22) Filed: Mar. 2, 2010

(51) Int. Cl. H02M 7/537

(52) U.S. Cl. 363/131

(57) ABSTRACT

A novel concept of converting a DC input to an AC output with a single active switch is disclosed. A series of topologies are developed to support the needs of different applications. Particular requirements for driving modern lighting devices are also addressed and supporting solutions are elaborated.

### BACKGROUND OF THE INVENTION

1. Field of the Invention

This invention generally relates to power conversion circuit that converts the electrical power from one form to another, and more particularly, to a unique concept of utilizing a single electronic switch to convert the electrical power from a DC format to an AC format to drive various type of loads including modern lighting devices etc. with a simple and low cost approach.

2. Description of the Related Art

The green energy initiative is an irresistible move today to fight the global warming and protect our planet. This move, in the meanwhile, brings enormous impact to almost every corner of the world, especially to the electrical power processing industry. Among many of the transitions in the power processing world a revolutionary move is undergoing in the lighting industry with which advanced power conversion technology is one of the keys for its success.

Among the various candidates today, Light Emitting Diode (called LED hereinafter) is by far the most ideal device for future illumination due to its superior light conversion efficacy, robustness, long lifetime and low pollution etc. At present, however, a critical factor of preventing its wide adoption in the world is its high cost. Before the cost meets the mass market expectation, other high efficiency lighting devices such as Cold Cathode Fluorescent Lamp (called CCFL hereinafter) etc. will provide intermediate solutions for a number of years.

It is understood that the operating voltage of CCFL device is in the range of several hundred volts to over 1000 volts, and a voltage of up to over 2000 volts needs to be applied at start up to ignite the lamp. It is also understood that the voltage applied to the CCFL has to be Alternate Current (AC) wave in order to prevent migration of the active materials inside the lamp, and favorable frequency of the AC supply for the lamp operation is in the range of a few tens of KHz. Therefore a drive circuit has to be employed to generate such high voltage, high frequency AC power to drive the lamp. For LED devices, because of the limited power of a single LED, a high number of LED's normally need to be connected in series to form LED strings and generate enough light. A drive circuit is also needed to convert an AC or DC supply to the relevant voltage for the LED operation.

It is also well understood that both LED and CCFL are non-linear devices. They stop conduction and extinguish when the operating voltage drops below certain critical level. This phenomenon imposes limitation to the lamp operation when brightness control is required. Especially in today's existing household installations, most brightness control devices are traditional triac based dimmer that tends to control the brightness by reducing the copped AC voltage to the lighting fixture. Under such circumstances, the LED or CCFL device may flicker or extinguish at low dimming level if the drive circuit lacks the capability of maintaining sufficient operating voltage for the lamps when the supply voltage from the dimmer reduces below critical level.

Under such circumstances, a practical lamp drive circuit design has to consider all the above issues in order to provide a reliable operation of the lamps in practical applications. On the other hand, when multiple CCFL or LED strings are employed in particular applications, current balancing circuitry would be needed to maintain the lamp current matching. All these additional functional circuitry will inevitably increase the complexity and cost of the system, produce additional power losses, and eventually make the solution less viable. Thereby it is the intention of this invention to incorporate the necessary functions in a single power conversion stage to provide a low cost, high efficiency drive solution. Apart from the lighting devices described herein, many other electrical devices would also need similar drive solutions to better meet people's needs.

### SUMMARY OF THE INVENTION

This invention discloses a concept to drive lighting devices or AC loads with a unique DC to AC power converter architecture. The proposed concept uses a single stage, single switch circuit in combination with a coupling capacitor to fulfill the functions of both voltage boost and DC to AC power conversion to supply a controlled AC power to the lighting devices or AC loads. The lighting devices or AC loads can be driven with regulated power over wide input voltage range and in addition, a non-dissipative current balancing of multiple lamps or loads can be realized by utilizing the matched impedance of the switching capacitors or serial inductance, or a transformer balancing network.

In one embodiment the boost diode of a boost converter is replaced by a coupling capacitor to function as a boost DC to AC inverter. The intrinsic AC operating nature of the capacitor automatically adjust the bias voltage across itself with the switching operation of the boost switch to conduct an AC current to the load with equal average value in the positive and negative cycle. When driving a non-linear load such as LED devices the operation of the circuit automatically boost the output voltage to the operating level of the LED devices to fulfill the energy transfer.

In one embodiment the flyback diode of a buck-boost converter is replaced by a coupling capacitor to function as a buck-boost DC to AC inverter. The intrinsic AC operating nature of the capacitor automatically adjust the bias voltage across itself with the switching operation of the boost switch to conduct an AC current to the load with equal average value in the positive and negative cycle. When driving a non-linear load such as LED devices the operation of the circuit automatically boost the output voltage to the operating level of the LED devices to fulfill the energy transfer.

In one embodiment the inductor of the buck-boost inverter is replaced by a transformer to provide an isolated inverter function. Such isolated buck-boost inverter can drive an AC load that has to be isolated from the input side.

In one embodiment a transformer is placed at the load position of the boost inverter or buck-boost inverter circuit, and the load is moved to the secondary side of the transformer to facilitate resonant operation of the switching circuit on the primary side of the transformer.

In one embodiment the LED strings are configured as a bi-directional circuit to work as an AC load. The AC passing nature of the coupling capacitor ensures balanced average current value of the positive and negative cycle. The bi-directional LED circuit can be configured with a bridge rectifier and a single LED string, or two identical LED strings connected in anti-parallel.

In one embodiment multiple AC loads are driven by the invented inverter circuit. Each AC load is connected in series with a coupling capacitor. All the capacitors have identical capacitance value and the matched impedances of the capacitors are utilized to balance the current of the AC loads.

In one embodiment multiple AC loads are driven by the invented inverter circuit. Each AC load is connected in series with an inductor to form an inductor-load branch. Such branches are connected in parallel to form a multi-branch array. Such array is then driven by the inverter and the LED currents or load currents of the branches are balanced by the inductance matching of the inductors.

In one embodiment multiple AC loads are driven by the invented inverter circuit. The AC loads are connected in series with a balancing transformer network to form a transformer balanced load array. Such array is then driven by the inverter and the currents of the load branches are balanced by the transformer balancing network.

### BRIEF DESCRIPTION OF THE DRAWINGS

FIG. 1A shows a basic conceptual circuit of a boost inverter to drive a bi-directional LED circuit.

FIG. 1B shows the concept of a boost inverter with multiple switching capacitors and using matched capacitance to balance the current of multiple bi-directional LED branches.

FIG. 1C shows the concept of a boost inverter with multiple switching capacitors and using matched capacitance to balance the current of another type of multiple bi-directional LED branches.

FIG. 2A describes the concept of a buck-boost inverter circuit that drives a bi-directional load.

FIG. 2B shows an isolated buck-boost inverter circuit that drives an AC load.

FIG. 3A shows the concept of a boost inverter with multiple inductors to drive the bi-directional loads and using the matched inductance to balance the load current.

FIG. 3B describes the concept of an isolated buck-boost inverter with multiple inductors to drive the bi-directional loads and using the matched inductance to balance the load current.

FIGS. 4A and 4B show the concept of using two different types of balancing transformer to balance the current of multiple bi-directional LED strings.

FIG. 4C shows the concept of a boost inverter with balancing transformer network to balance the current of multiple bi-directional LED strings.

FIG. 4D describes the concept of an isolated buck-boost inverter with balancing transformer network to balance the current of multiple bi-directional LED strings.

FIG. 5A shows an isolated buck-boost inverter with transformer isolation to the load;

FIG. 5B shows an example of using a full wave rectifier circuit to drive a DC load from the secondary side of the isolation transformer; and FIG. 5C shows another type of isolated buck-boost inverter with the coupling capacitor on the primary side of the transformer and in the meanwhile, using matched capacitance to balance the current of multiple bi-directional LED strings.

### DETAILED DESCRIPTION OF THE INVENTION

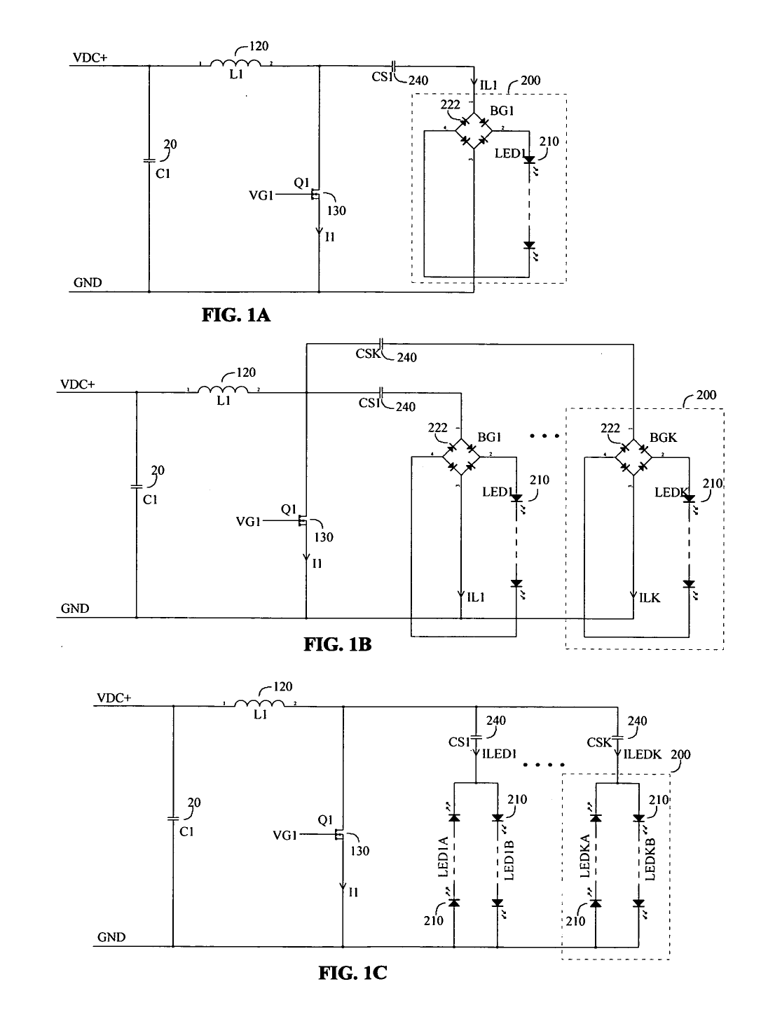

FIG. 1 shows a conceptual circuit of the invented boost inverter. As shown in FIG. 1A, a boost inductor 120 is connected from a DC input VDC+ to the drain of a power MOSFET 130. The source of the power MOSFET is connected to the return terminal GND of the input supply. A coupling capacitor 240 couples the energy of the inductor to the output with one of its terminal connected to the drain of the power MOSFET 130, and the other terminal as the output terminal of the boost inverter in conjunction with the return terminal GND. The load is a bi-directional circuit comprised by a bridge rectifier 222 and an LED string 210 with the two AC input terminals of 222 connected to the output of the boost inverter, i.e. between the output terminal of capacitor 240 and return terminal GND. The DC output terminals are coupled to the LED string 210 with the positive output connected to the anode of 210 and the negative to the cathode of 210. Thus the bridge-LED circuit appears as a bi-directional load, herein represented as 200, to the boost inverter to allow the load current to flow in both directions. Such bi-directional load that allows the current to flow through it in both directions will be called ‘AC load’ hereinafter. In contrast, the other type of the load that allows the current to flow through it in only one direction, such as an LED or LED string itself, and is represent as 210 in FIG. 1A, will be called ‘DC load’ hereinafter.

During operation when the power switch 130 is first turned on, current flow from the positive input VDC+ through boost inductor 120 and the power switch 130 and back to the return terminal GND, and build up linearly. When 130 is turned off, the inductor current changes its course to circulate through the switching capacitor 240, the bridge-LED load 200, and back to the return terminal GND. During the course when the current flows to the load, it also charges capacitor 240 and build up the voltage across 240. After a number of cycles when the voltage across 240 builds up to the level that exceeds the conducting voltage of the load 200, discharge from capacitor 240 to the load will occur when 130 is turned on. Thus eventually a dynamic equilibrium operating state will be established that when power switch 130 is off, the inductive energy is transferred to capacitor 240 and the load, and when 130 is turned on, the inductive energy builds up and in the meanwhile, the energy charged to capacitor 240 discharges to the load with current flow in reverse direction. Because of the AC passing nature of the capacitor, the energy charged to 240 during 130 off period and the energy discharged from 240 during 130 on period will be equal at steady state operation, and further result in balanced energy transfer in the two opposite current flowing cycles to the load.

It can be further understood that because of the forward conducting voltage of the LED string 210 in FIG. 1A, hereinafter referred as V_{FLED}, the discharge of capacitor 240 stops when its voltage drops to the equal level of V_{FLED}, if the switching MOSFET 130 remains on till then. Under such circumstances, the voltage of 240 ripples above a DC bias level of V_{FLED} with periodic switching operation of 130, rising when 130 is off, and falling when 130 is on with a discharge equal to the charge obtained during 130 off period. Further, if the on period of 130 is shorter than the time needed for capacitor 240 to discharge to the level of V_{FLED}, the voltage across 240 will rise to a bias level higher than V_{FLED} at which a new equilibrium state is established with balanced charge and discharge of 240 during off and on period of 130 respectively. On the other hand, if the load of FIG. 1A is a resistive type that conducts current at any non-zero voltage level, the DC bias level of capacitor 240 will be zero when the on period of 130 is long enough to allow a complete discharge of 240, and similarly, stay at a DC level above zero at which an equilibrium of balanced charge and discharge of 240 is established when the on period of 130 is shorter than the complete discharge cycle time of 240.

Such operation property of the circuit brings an advantage of using matched capacitive impedance to balance the LED current when driving multiple LED strings. A typical example is illustrated in FIG. 1B. As shown in FIG. 1B, LED strings LED1, . . . , LEDK are connected with a corresponding rectifier bridge 222 and then in series with a coupling capacitor 240 respectively. Current matching of the LED strings is accomplished by using identical capacitance value for all the coupling capacitors CS1 through CSK, and the capacitance value is selected such that at the given switching frequency, the voltage drop across the capacitor is significant enough in comparison with the LED operating voltage. Thus the effect of the difference in LED operating voltage will be largely suppressed. Given a 5% tolerance of the operating voltage of a group of 30V LED strings, the resulted difference of the voltages across the balancing capacitors is 1.5V. If the working voltage of the capacitor is chosen to be equal to the LED operating voltage, i.e. 30V, the difference of 1.5V is translated to 5% difference in the current flowing through the capacitor which is essentially also the current of the LED strings. Because capacitor is a reactive component, the power loss on the capacitor can be easily minimized by using a low loss type. Such type of capacitor is readily available today and thus, a fairly good LED current matching can be obtained without excessive power dissipation and cost increase.

FIG. 1C shows an example with another type of AC LED structure. As shown herein in FIG. 1C, each AC LED branch is comprised with two LED strings in anti-parallel connection and thus allows current flowing in both directions when the corresponding LED string is forward biased. The coupling capacitor in series with such AC LED structure serves the same function of AC current passing and LED current matching as described hereinbefore. It should be noted that each individual LED string conducts only in half of a complete switching cycle and hence it seems that the utilization of the LED capacity is about half compared with the structure in FIG. 1B. In actual application, however, in order to fully utilize the capacity of the LED string, the peak working current of the LED string can be doubled. Because the light output of the LED is largely proportional linear to its forward current over a wide range at constant temperature, such approach will produce same amount of light output with almost the same power consumption and same number of LED strings.

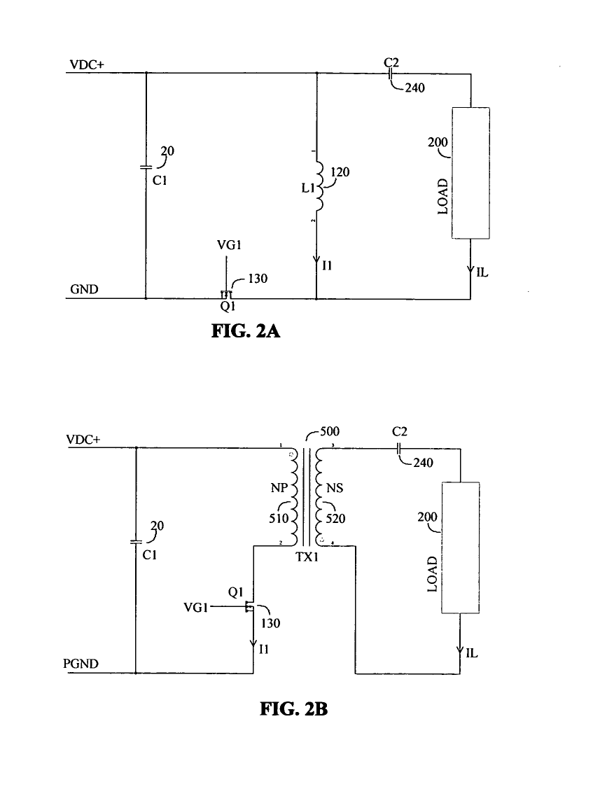

The boost inverter concept can also be extended to buck-boost topology. FIG. 2A shows such circuit concept. In FIG. 2A the circuit branch of the coupling capacitor and load is paralleled to the boost inductor 120 instead of the power switch 130. Similarly, with the AC passing nature of the coupling capacitor 240, an equilibrium state will be established during operation that the energy charged to 240 during 130 off period and the energy discharged from 240 during 130 on period will be equal at steady state and the load 200 sees an AC current with balanced average value in the positive and negative cycle.

The buck-boost inverter concept can be further extended to a transformer based approach when isolation between the input and output is needed or a large voltage transfer ratio is required. The basic concept is illustrated in FIG. 2B. As shown in FIG. 2B, the inductor 120 in FIG. 2A is replaced by a transformer 500 with its primary winding 510 connected in series with the switching device 130, and the secondary winding 520 coupled to the load through coupling capacitor 240. During operation when 130 is turned on, a voltage is developed in the secondary winding to generate a current flowing from the lower side terminal of 520, the load 200, the coupling capacitor 240, and back to the upper side terminal of 520. The capacitor is charged by the current and the voltage across it changes accordingly with positive increase on the right side. In the meanwhile, an inductive current also builds up in the transformer primary winding 510 through the path from positive input VDC+, primary winding 510, power switch 130 and the input return terminal PGND. When 130 is turned off, the inductive current in primary winding 510 transfers to the secondary side through the magnetic coupling between 510 and 520 and flows in the path from the upper side terminal of 520, the coupling capacitor 240, the load and back to the lower side terminal of 520. During the course the voltage across capacitor 240 also changes with the current in the polarity of positive increase on the left side. With the periodical switching on and off of 130, an equilibrium operating state will eventually established after a number of cycles that the current flowing to the load when 130 is on equals to the current in the reverse direction when 130 is off with a bias voltage across 240 automatically established by the AC passing nature of the capacitor. This circuit essentially operates in the similar way as the buck-boost inverter described herein above except that the energy is transferred to the capacitor and load through the transformer coupling, and hence will be called isolated buck-boost inverter hereinafter. It should noted that while the transformer in FIG. 2B shows a certain polarity relation between the primary and secondary windings for the convenience of description, the operating principle also applies to the reversed transformer polarity configuration except that the AC current of the load reverses its polarity accordingly. It should also be noted that the load can be a linear resistive type, a bi-directional LED structure as described hereinbefore, a CCFL lamp, or any other types that allow bi-directional current flow.

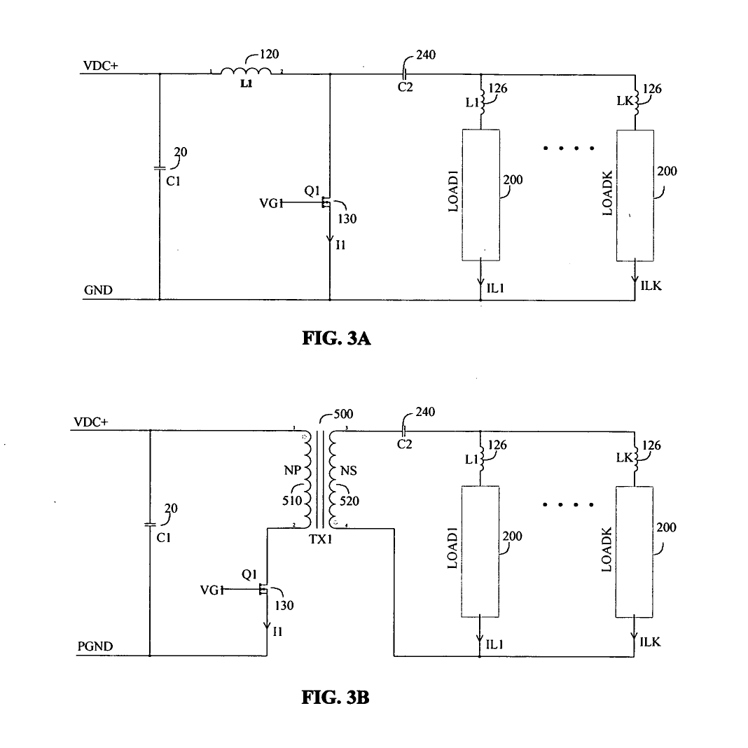

When the load consists of multiple branches, coupling capacitors can also be deployed in series with each branch in isolated inverter topology to balance the load current with the matched capacitance of the coupling capacitors in the same way as FIGS. 1B and 1C. In fact, because of the AC nature of the output signal, all types of reactive components can be utilized to realize non-dissipative load current balancing with their matched AC impedance. FIGS. 3A and 3B shows a concept of utilizing matched inductance to balance the load current. Note that in FIGS. 3A and 3B a coupling capacitor 240 is still employed to provide AC coupling to the whole load bank, and each load branch has a balancing inductor in series with the load branch. When all the inductors have equal inductance and the voltage drop across the inductor is significant enough in comparison with the load voltage, the current of the load branches can be balanced by the matched inductance of the balancing inductors. Also note that the load can be different type so long as it allows bi-directional current flow. The bi-directional LED structures as described hereinbefore, or CCFL lamps, are typical examples of such load in practical applications.

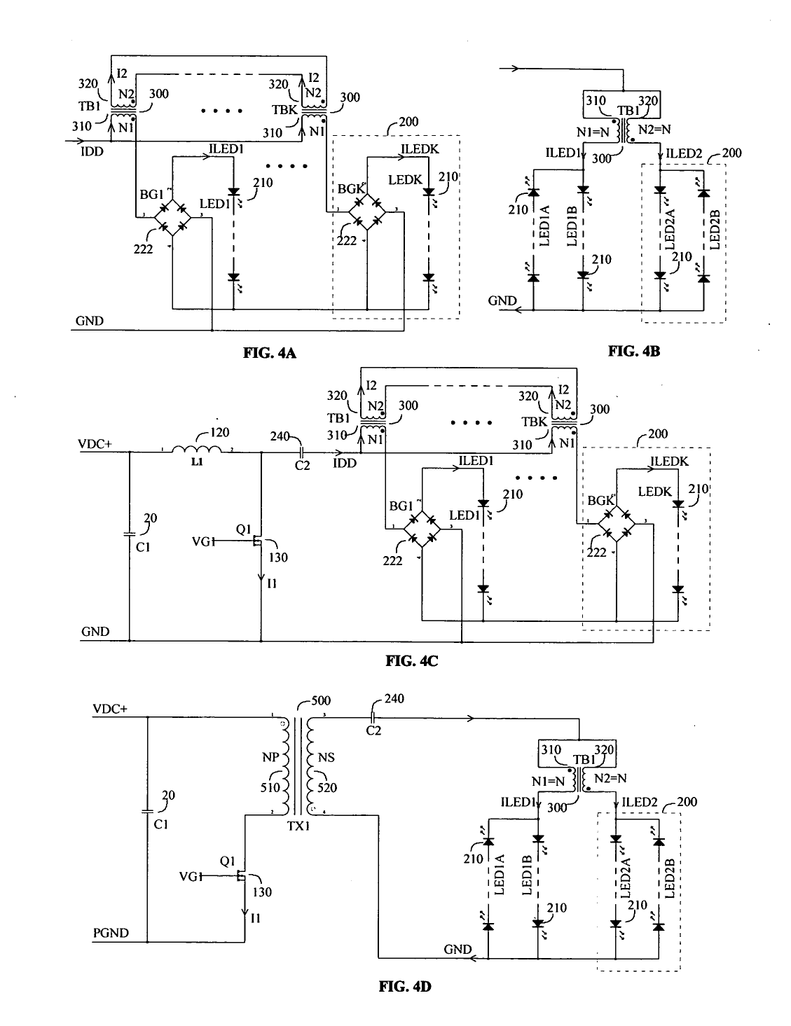

FIG. 4 shows another method to balance the load current by using a balancing transformer network. In fact, the transformer balancing network described in FIGS. 4A and 4B was invented by Jin and Ushijima respectively to balance the current of multiple CCFL lamps. These transformer balancing networks are perfect fit with the boost inverter, buck-boost inverter and isolated buck-boost inverter described hereinabove to provide a low cost, low loss drive solution for multiple AC loads, typically including CCFL lamps and bi-directional LED structure as shown in FIGS. 4C and 4D.

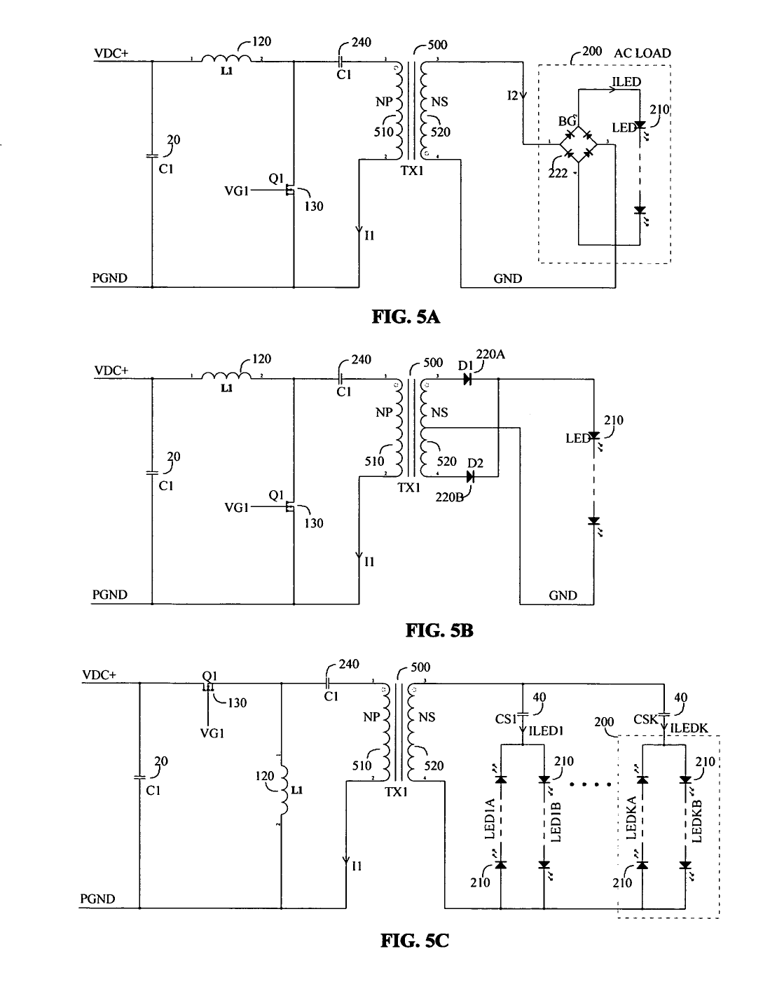

The existence of both inductance and capacitance component in the above described converter circuit also provides the possibility to make use of the resonance between these reactance components to realize soft switching operation of the circuit. In the boost inverter circuit illustrated in FIGS. 1A and 2A resonance between the boost inductor 120 and coupling capacitor 240 can be purposely manipulated when power switch 130 is turned off to create zero voltage crossing instant over the D,S terminals of 130 to realize soft switching operation of the device. In the isolated buck-boost inverter circuit described in FIG. 2B, however, because the coupling capacitor 240 is on the secondary side of the transformer while the switching device 130 is on the primary side, a controllable resonance is difficult to obtain. In order to obtain soft switching operation with isolated power transfer, the coupling capacitor can be moved to the primary side of the transformer. FIGS. 5A and 5C shows such circuit configuration. Because at steady state switching operation the coupling capacitor 240 couples only AC current to transformer 500 and transformer 500 couples only AC voltage to the secondary side, the energy supplied to the load from the secondary winding 520 is also inherently in AC format with balanced average value in positive and negative cycle. With such AC output, the bi-directional LED structures, or CCFL lamp, or other types of AC load can be connected directly to the output from the secondary winding 520. And furthermore, when multiple load branches are to be driven, the load current balancing methods described hereinabove, including the matched capacitance balancing, matched inductance balancing, and the balancing transformer network etc. can also be employed to provide balanced drive to the load branches.

Finally, because in FIGS. 5A and 5C the DC to AC conversion is accomplished on the primary side of the transformer, the AC output from the secondary winding of the transformer can be rectified to a DC format to supply a DC load when necessary. FIG. 5B shows an example to convert the AC signal with full wave rectification and supply to a LED string. Other types of rectifier circuit such as bridge rectifier or current doubler rectifier circuit can also be employed to fulfill the function.

From the explanations of the invention hereinabove, it should be noted that while certain embodiments of the inventions have been described, these embodiments are presented by way of example only, and are not intended to limit the scope of the inventions by any means. The power switching device, the load, and the transformer in the description can be different types other than the types described in the examples. Furthermore, various omissions, substitutions and changes in the form of the methods and systems described herein may be made without departing from the spirit of the inventions. The accompanying claims and their equivalents are intended to cover such forms or modifications as would fall within the scope and spirit of the invention.

I claim:

1. A boost inverter circuit comprised at least by an inductor, an electronic power switch, a coupling capacitor, a DC input, and a load, one side of the said inductor is connected to the first terminal of the said DC input, and the other side of the inductor is connected to the first power switching terminal of the said electronic power switch, the second power switching terminal of the electronic power switch is connected to the second terminal of the said DC input, the said coupling capacitor is connected in series with the said load and such serial capacitor-load circuit is connected in parallel to the electronic power switch, the load is a bi-directional type that allows current flowing through it in both directions, the on and off switching operation of the power switch generates an AC voltage across the load and an AC current flowing through the load.

2. A buck-boost inverter circuit comprised at least by an electronic power switch, an inductor, a coupling capacitor, a DC input, and a load, the first power switching terminal of the said electronic power switch is connected to the first terminal of the said DC input, and the second power switching terminal of the electronic power switch is connected to one side of the said inductor, the other side of the inductor is connected to the second terminal of the said DC input, the said coupling capacitor is connected in series with the said load and such serial capacitor-load circuit is connected in parallel to the inductor, the load is a bi-directional type that allows current flowing through it in both directions, the on and off switching operation of the power switch generates an AC voltage across the load and an AC current flowing through the load.

3. An isolated buck-boost inverter circuit comprised at least by a transformer, an electronic power switch, a coupling capacitor, a DC input, and a load, the said transformer has at least one primary winding and one secondary winding, the first terminal of the primary winding of the transformer is connected to the first terminal of the said DC input, and the second terminal of the primary winding is connected to the first power switching terminal of the said electronic power switch, the second power switching terminal of the electronic power switch is connected to the second terminal of the said DC input, the said coupling capacitor is connected in series with the said load and such serial capacitor-load circuit is connected in parallel to the two terminals of the secondary winding of the transformer, the load is a bi-directional type that allows current flowing through it in both directions, the on and off switching operation of the power switch generates an AC voltage across the load and an AC current flowing through the load.

4. An inverter circuit of claims 1 and 2, with an additional transformer, the transformer has at least one primary winding and one secondary winding, the primary winding of the transformer is connected to the same position of the load in claims 1 and 2, the load is moved to the secondary side of the transformer and connected across the two terminals of the secondary winding, the on and off switching operation of the power switch generates an AC voltage across the load and an AC current flowing through the load.

5. The inverter circuit of claims 1, 2, 3 and 4, with more than one load and the same number of coupling capacitors, each load is connected in series with a corresponding coupling capacitor to form a serial capacitor-load branch, all such serial capacitor-load branches are connected in parallel to the same position of the capacitor-load circuit in claim 1, 2 and 3 to replace the original capacitor-load circuit of claims 1, 2, and 3, or the same position of the load in claim 4 to replace the original load of claim 4, all the coupling capacitors have the same capacitance value and the matched capacitance value is utilized to balance the current of the loads.

6. The inverter circuit of claims 1, 2, 3 and 4, with more than one load and each load is connected in series with an inductor to form a serial inductor-load branch, all such serial inductor-load branches are connected in parallel to the same position of the load in claims 1, 2, 3 and 4 to replace the original load of claims 1, 2, 3 and 4, all the inductors have the same inductance value and the matched inductance is utilized to balance the load current.

7. The inverter circuit of claims 1, 2, 3 and 4, with more than one load and each load has a designated balancing transformer, all the balancing transformers have a primary winding and a secondary winding, the turns ratio of all the balancing transformers are preferably equal to set equal load current, or different to control the load current proportionally according to the turns ratio, the primary winding of each balancing transformer is connected in series with the designated load to form a serial circuit branch, and all such serial branches are connected in parallel to the same position of the load in claims 1, 2, 3 and 4 to replace the original load of claims 1, 2, 3 and 4, the secondary winding of all the balancing transformers are connected in series to form a single circuit loop such that under normal operation, the induced currents in the secondary windings all flow in the same direction in the said single circuit loop, such transformer-load configuration is utilized to match the load current under the switching operation of the inverter.

8. The inverter circuit of claims 1, 2, 3 and 4, with at least two loads and one balancing transformer to replace the original load of claims 1, 2, 3 and 4, the said balancing transformer has two windings with equal number of turns, each winding of the transformer is connected in series with a designated load to form a serial circuit branch, and such serial circuit branches are connected in parallel to the same position of the load in claims 1, 2, 3 and 4 to replace the original load of claims 1, 2, 3 and 4, the two windings of the said balancing transformer are connected in opposite polarity such that the currents in the two windings generate opposite magnetic flux in the transformer core, such current balancing circuit can be cascaded to drive more than two loads.

9. The inverter circuit of claim 4, a rectifier circuit can be utilized to convert the AC output from the secondary winding of the transformer to a DC voltage and supply to a DC load.
